(19) United States
(12) Patent Application Publication
(10) Pub. No.: US 2007/0067405 A1
(43) Pub. Date: Mar. 22, 2007

(54) MODERATED ANONYMOUS FORUM

(76) Inventor: Joshua M. Eliovson, Roseland, NJ (US)

Correspondence Address: DICKSTEIN SHAPIRO LLP, 1177 AVENUE OF THE AMERICAS (6TH AVENUE), NEW YORK, NY, 10036-2714, US

(21) Appl. No.: 11/533,736

(22) Filed: Sep. 20, 2006

Related U.S. Application Data
(60) Provisional application No. 60/718,301, filed on Sep. 20, 2005.

(51) Int. Cl. G06F 15/16

(52) U.S. Cl. 709/206

(57) ABSTRACT

A moderated forum that provides an arena for anonymous public discussions in and among a given on-line or virtual community as well as discussions between separate on-line or virtual communities. Separate virtual communities have the ability to share views and opinions. While in certain instances the interaction can be on the limited controlled basis, other scenarios anticipate total unlimited access. Additionally, the system can be mined to extract characteristic data of the users and the forum topics.

### CROSS-REFERENCE TO RELATED CASES

This application claims priority to U.S. Provisional Application No. 60/718,301, filed Sep. 20, 2005, the entirety of which is incorporated herein by reference.

### FIELD OF INVENTION

The present invention relates generally to information communication and information processing systems and, more particularly, to a method for communicating messages from one or more anonymous senders to one or more anonymous recipients using a moderated forum.

### BACKGROUND OF THE INVENTION

A number of everyday situations benefit from the ability of a person or group to send a message anonymously to another person or group. Government tip-hotlines for instance solicit information from the public to help solve or forestall crime but often do not require callers to identify themselves. Crisis counseling hotlines similarly enable callers to discuss concerns without fear of being identified. At heart to the efficacy of these situations is the fact that sender anonymity can enhance the quality and truthfulness of communication. By ensuring sender privacy and confidentiality, anonymity reduces perceived risk and cost by the sender to providing the communication.

In the arena of human feedback regarding employment, consumer products, and other topics, anonymity is critical. Feedback by employees about an employer, brainstorming topics, or customers about a product or service can place those providing the feedback in awkward or sensitive positions should their identity not be safeguarded. Anonymity includes two components: (a) a sender's identity being shielded from a recipient and (b) the recipient not being able to trace the message sending process in a manner that reliably identifies the sender.

Equally important as anonymity are other characteristics of the feedback sender, feedback process, and feedback recipient that mitigate the efficacy and real-world usability of a feedback application. These key characteristics can be summarized as (a) limited sender access to transmission tools, (b) limited sender sophistication, (c) the ephemeral nature of feedback insight, (d) the voluntary nature of feedback, (e) the need for sender validation, and as noted by the inventor of the present application, an open moderated forum that enhances interaction.

The first two characteristics describe the feedback sender(s). In some circumstances, would-be senders do not have access to tools such as a computer or Internet access. Many would-be feedback senders also do not have the sophistication for undertaking steps required such as using a public-private key to encrypt messages.

The next two characteristics involve the feedback process. Feedback comments tend to be fleeting in that they fade quickly from memory. Feedback also tends to be a voluntary activity and consequently requires systems that are easy to use on the part of would-be senders.

The fifth characteristic describes the recipient(s). For a recipient to value comments received, he or she has to be reasonably confident that messages are being received from authorized senders. A manager, for instance, may need to be assured that the feedback he or she is receiving only comes from his or her employees and not his or her superiors. This need has to be balanced by the anonymity needs of senders. Please note that for ease of illustration, reference to a one sender to one recipient feedback situation will be used below, but those trained in the art will appreciate that the invention disclosed in this application could be used by a diverse set of senders and recipients in various roles and contexts.

U.S. Pat. No. 5,668,953 discloses a method and system for handling individual complaints, possibly in an anonymous fashion. This invention is an example feedback processing application that is intended for a specifically defined type of feedback i.e., complaints. The invention is intended for communication between a consumer and a vendor where the message involves a complaint requiring response by the vendor. As a result of handling complaints, the invention requires a two-way communication channel so that the vendor can reply to the consumer complaint. The invention also requires users to have access to computer networks and to an electronic mail address. This invention also does not directly authenticate senders; a malicious sender could fabricate complaints without ever having purchased a vendor's product. Efforts to ensure anonymity from traffic monitoring are also minimal. The applicability of the invention to contexts other than that of its design is consequently limited. For instance, its construction is not purposed on enabling a sender to send feedback to multiple recipients simultaneously.

U.S. Pat. No. 6,510,427 describes a system for the capture and analysis of customer feedback that addresses most of the failings of other systems. Nevertheless, the aim of the invention is to aggregate feedback data collected in order to perform data mining and other analytic functions. This necessitates that feedback data be intermediated by service representatives in order to capture the data and to structure the data in a manner usable by the system for subsequent analysis. The invention is limited to one recipient, the database aggregating collected data, and it potentially compromises anonymity due to service representative intermediation.

U.S. patent application 20020116462 discloses a method for handling feedback generated by persons within a group setting. This invention enables real-time feedback within a classroom in order to enhance the learning process. It can be used for anonymous feedback in cases where senders' feedback messages are stripped of sender identification. The invention is suitable primarily for situations where senders are interacting with recipients in an insular context. As a real-time tool, this invention is also limited in its ability to stop traffic monitoring efforts. It is also limited to electronic devices able to quickly provide the real-time feedback collection and data display services provided by the invention.

Several inventions have been created in the employee management arena, but most aim at managing employee information for use by employers rather than enabling anonymous employee interaction to employers. U.S. Pat. No. 6,049,776 describes a human resource management system that is focused on managing employee profile information and scheduling employee activities and tasks; however no functionality is specifically designed for anonymous employee interaction.

Several methods and systems enabling anonymous communication between parties have been disclosed which could be fashioned to permit anonymous interaction. For instance, U.S. Pat. No. 5,907,677 discloses a method enabling anonymous communication between two parties by assigning each party a code used as a pseudonym for inter-party communication. This invention could be utilized for interaction applications if the true identify of the recipient were revealed to would-be senders. In this case, for recipients to then also act as senders, they will have to maintain two user accounts, one where their identity is exposed and one where their identity is hidden, a cumbersome solution. Because users of the system are identified by a pseudonym, in some situations it could also be possible to estimate identities through an analysis of which pseudonyms are part of what communication flows. Furthermore, no manner of checking that a message received by a recipient comes from an authorized sender is built into the invention. In addition, the invention has to store sender information in order to assign a sender the pseudonym code, diminishing the perceived anonymity by the sender. No anti-traffic monitoring initiatives are provided. U.S. patent application 20030061484 discloses a similar method whereby a trusted third party assigns a code to users. This code is then used as a means for user authentication and anonymous communication with other users. Due to its use of digital certificates and virtual meeting rooms, this invention is only reliably implemented through electronic media, limiting accessibility to some would-be senders.

U.S. Pat. No. 5,913,212 discloses a system enabling anonymous electronic communication between two parties. This invention is crafted for personals applications (e.g. the invention is an electronic analog to newspaper personal advertisements), and consequently its usability for interaction applications is limited. As with U.S. Pat. No. 5,907,677 above, recipients would need to identify themselves in order for senders to communicate with them. This invention also requires users to utilize computer networks like the Internet to obtain access, limiting accessibility to some would-be senders. The system also collects personal profile information, which some would-be senders may be reluctant to furnish. Lastly, no authentication scheme for matching senders to recipients is provided. U.S. Pat. No. 5,884,272 provides for an invention that also enables anonymous communications between parties whereby personal information is used to match parties based upon criteria without initially revealing their identity. In this invention, the parties are given means to progressively reveal identifying information to each other. This invention poses the same failings in respect to feedback applications as U.S. Pat. No. 5,913,212 above. U.S. Pat. No. 6,665,389 discloses a system to empower anonymous matching within the context of a dating service. In addition so some of the setback of the above with respect to its applicability for anonymous interaction applications as contemplated, this invention requires both parties to disclose personal information in order to utilize the system, which would be unpractical in promoting trust of anonymity by users. U.S. patent application 20030084103 provides an invention with similar function as the above.

U.S. Pat. No. 6,209,100 discloses a method for enabling anonymous posting of messages to a moderated forum. The essence of the invention involves forum administrators removing identifying information from inbound messages and then posting those messages deemed appropriate into a forum. While this invention could be utilized for interaction applications, it does not establish clear sender-to-recipient authentication and potentially enables anyone with access to the forum to view posted messages. Furthermore, a third-party, the forum administrator, performs qualitative review of messages, which may censure valid messages.

U.S. Pat. No. 5,812,670 describes a method for anonymous communication between two parties. This method can be utilized for anonymous interaction applications and does address many of the shortcomings of other applications. Nonetheless, it involves sophisticated tools such as encryption keys which are not accessible to some would-be interaction senders and which limit its usability to electronic media for sending messages. Consequently, the invention is not well-suited for handling relatively low-value interaction. An expressed scheme for validating that recipient messages come from authorized senders is also not included. U.S. patent application 20020004900 discloses an analogous method for anonymous communication through the use of anonymous certificates. In this invention, user identity is shielded, but a third party certificate authority asserts characteristics about the sender to a recipient.

U.S. Pat. No. 6,591,291 discloses a method for anonymous communication by remailing electronic mail messages. The recipient is not able to identify the sender because a remailer has substituted an aliased electronic mail address for the sender's.

U.S. patent application 20040111612 describes an invention whereby a central system intermediates between group communications in such a manner as to enable message recipients to reply to a sender without the need to know the sender's identity. This invention is complementary to that contemplated in this application by potentially extending its reply-to-sender capabilities in limited contexts; nevertheless, its particular emphasis makes it distinct in capability and scope. Its focus on enabling reply capability limits the invention by requiring a sender to disclose identifying information.

### SUMMARY OF THE INVENTION

The disclosed system is an online message-board based community. In one embodiment, the community includes or is alternatively based upon moderated chat.

The online system provides one or more of:
a means of extracting personal information and data from a targeted population;
a means of aggregating personal data relating to a specific population;
a means of effecting ‘soft-interventions’ for individuals at risk for such things as suicide, drug abuse, alcohol abuse, eating disorders, physical abuse, sexual abuse, self mutilation, violent behavior, religious guidance, and the like;
a peer-to-peer support environment;
a discreet means of anonymously connecting individuals seeking advice with trustworthy advisors including but not limited to clergy, clinicians, health counselors, professional advisors, social workers, and the like; and
a subscription-based searchable database of anonymous personal data relating to targeted populations.

The system and method provide means for public discussions between separate online communities and/or private (sub-group) discussions between members of one or more communities who share common criteria.

In one embodiment, the system includes an extranet for reporting member behavior to third parties. The system generally provides the ability to escalate a post that is already on the site to be used even for a site that does not pre-moderate but only reviews posts on a routine basis once they are live.

The system also provides an optional masking feature that allows members of site to mask their identity completely, meaning both their real and their virtual identity (screen-name) for individual posts to the system, even to be used for any type of anonymous forum, even for a site that does not moderate in any manner.

It should be noted that posts to the system can be locked, either by a moderator or automatically based on predefined system guidelines.

### BRIEF DESCRIPTION OF THE FIGURE

FIG. 1 is a depiction of the system according to one embodiment of the invention.

### DETAILED DESCRIPTION OF THE INVENTION

The model of the moderated forum provides an arena for public discussions in and among a given on-line community as well as discussions between separate on-line communities. In this manner, separate virtual communities have the ability to share views and opinions. While in certain instances the interaction can be on the limited controlled basis, other scenarios anticipate total unlimited access.

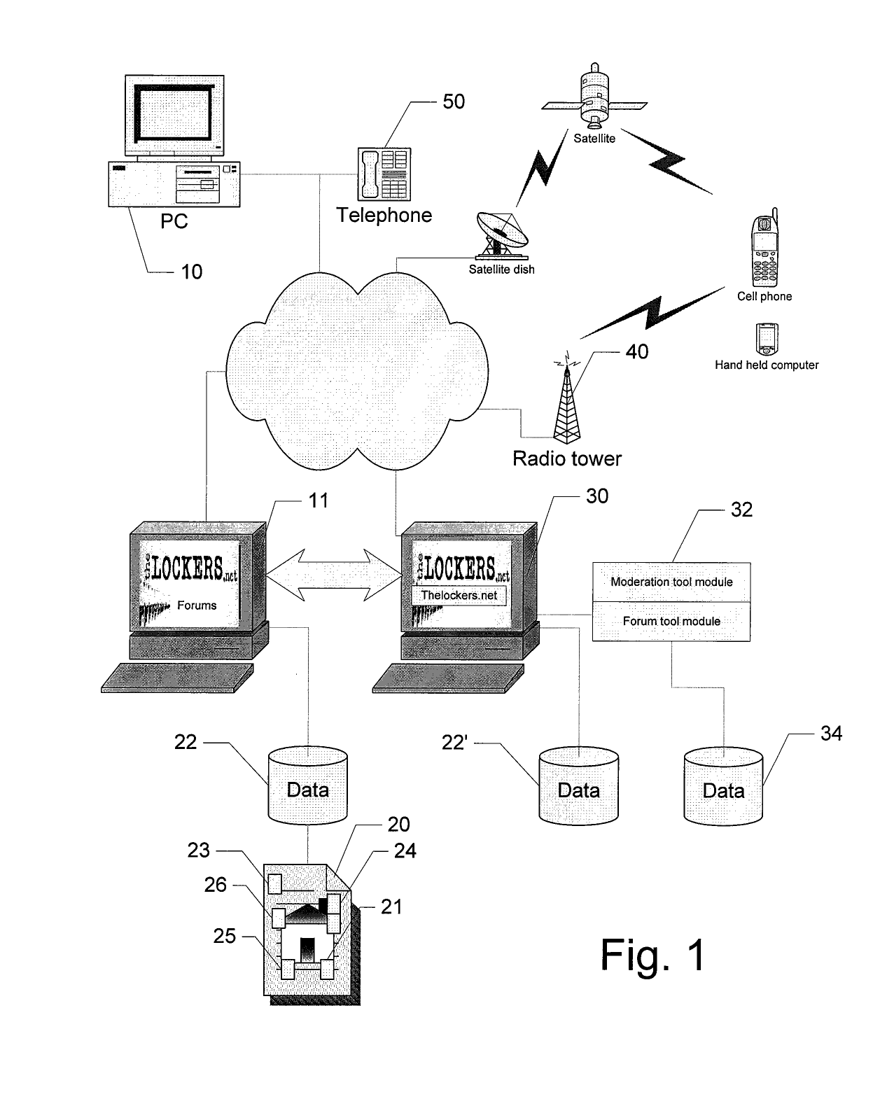

As shown in FIG. 1, a web page 20 is stored in database 22 or 22′. The web page 20 includes one or more of a message 26, a mask/unmask selection button 25, a reply button 21, a react button 24, and a mark private or private discussion button 23. The web page is hosted on a server 11. A second server 30 hosts forum moderation tools as well as the forum tools 32. It should be noted that in one embodiment, the forums and tools are on a single server. A user 10 logs onto the system using an individual password and user name. Additionally, administrators have logins which allow them to access the moderation tools and forum tools 32. In one embodiment, users can also access the system using hand held computers, cell phones, PDAs, and the like. Additionally, when an administrator or support staff member wants to contact a specific user, that user can be contacted via Email or, if the user has provided a telephone number, via telephone.

In one embodiment, the forum tools include data collection tools. The data is then stored in database 34, 22, or 22′. The data includes member characteristic data, forum data, topic data, and the like. This data can then be analyzed and mined for various information.

In the preferred embodiment, a member of a given community may only participate in the community in which that person is a member. However, a person is able to become a member of multiple communities. Additionally, one can visit a community and read other communities' threads without becoming a member of that community. Various communities are interrelated.

A person that is a member of a first community is preferably able to respond to posts in the community in which that person is not a member. This person would be able to “react” to a post instead of reply to a post. In one embodiment, postings are designated as “replies” or “reacts” so that viewers of the forum are aware of the source of the post, i.e., whether or not the person posting is a member of the community.

In another embodiment, reacting to a post begins a public discussion which is a discussion between the linked communities. The starting point of the public discussion is the forum posting that was reacted to. A public discussion can also be initiated by posting a discussion topic and selecting communities the poster wishes to include in the public discussion.

The system is adapted so that members of a single community that share common criteria can engage in private discussions. These private discussions can be a one-to-one discussion or an open forum discussion open to members of the community. Private discussions enable members of the virtual community to start a sub-group discussion between a more select sub-section of the membership, based upon specific criteria. In one embodiment, the specific criteria are pre-defined common criteria. For example, in a forum for a given high school, a private discussion sub-group can be the boys' baseball team or the girls' field hockey team. In a preferred embodiment, a private discussion option is available on a main web page. Selecting the private discussion option will open a web page similar to a page used to create a new thread. In addition to the create new thread options, the private discussion option allows a member to enter a brief description or purpose of the private discussion as well as define criteria for the various individuals that will define the subgroup. In a preferred embodiment, members meeting the criteria for the subgroup would receive an email inviting them to participate in the subgroup. In another embodiment, only members meeting the predefined criteria will be able to enter the subgroup although all members of the community will be allowed to view the topic of the community.

As the present system and method describe a moderated forum, a system and method exists to report member behavior to third parties. In one embodiment, posts are reviewed by a moderator prior to posting. In another embodiment, posts are reviewed after posting. In yet another embodiment, posts are not reviewed. Finally, a combination of the three moderating type styles is used. In one embodiment, a moderation system overlays the forum system such that posts are reviewed during a moderation process. Additionally, a system would preferably flag posts for review by clinical or support staff for those posts not noted during an initial review. In a preferred embodiment, flagged posts appear in a separate on-line portal, accessible via login by the community administrator and/or the support staff. These flagged posts would fall within specified criteria such as individuals at risk for harming themselves, individuals at risk for harming others or other behavior which would necessitate intervention. In a preferred embodiment, flag posts are assigned by an administrator to a specific support staff member or the group in general.

An administrator or support staff member logs into the system would find a list of posts from the communities for which they act as administrator or support staff for their review. The support staff member is able to comment on the posts, suggest interventions, and send the member pre-defined or custom emails. It should be noted that, in the one embodiment, the support staff does not see the email address to which the comment is being sent, i.e., it is anonymous recipient of the message. In a preferred embodiment, the support staff member or administrator is able to see a snapshot view of the member to see all of the user's posts. Additionally, the snapshot would preferably include the member's profile. In certain embodiments, the administrator or support staff member would be able to view the poster's email address or other identifying data. Any activity by a member, support staff member, administrator or the like is logged to a tracking file so that the system tracks any interactions between given members.

Other features of the forums include a masking feature and a locking feature. The masking feature allows members of a site to mask their identity. When a user masks their identity, either their real or virtual identity for a given post is omitted from the posting. In one embodiment a surrogate identity generated by the system is attached to the given post. A member can mask a post at any time either prior to posting or after the message has been posted to the forum.

Additionally, a user or moderator can lock a posting or message. A moderator of the community can request that a community or thread be locked. Administrators or support staff members receive an email notification of a lock post or request to lock a post. In a preferred embodiment, only administrators can unlock a locked post. Additionally, in a preferred embodiment, moderators provide explanations as to why threads are locked. In one embodiment, the moderators must provide an explanation to administrators as to why the threads were locked.

The system is an online community. The system achieves unique results in user behavior such as the sharing of personal information, and/or the revealing of emotional feelings, and/or the sharing of more guarded opinions on virtually any subject matter. The system achieves the results due to a unique combination of criteria. Because of the sharing of the above information, aggregation is possible. The criteria include, but are not limited to, the combination of the following four elements:

Forums are community specific. A community is any group of people that may be grouped socially, religiously, physically, emotionally, demographically, and/or institutionally.

Where applicable, forums are regionally specific, and/or members are grouped regionally within a more general forum. A region can be as broad or specific as necessary to create an effective feeling of intimacy among the online community's members. For example, a region can be ‘North America’, or a region can be a group of towns, or a region can be an individual street, or any other similar type of variation. In fact, a region may be a particular school, company, club, or the like.

Forums are guided by a policy of “issues, and not names.” The forums focus discussions exclusively on issues relating to the members lives, selves, community, world, families, friends, work, etc; at the same time, the forums are anonymous, disallowing the sharing of personally identifying information, except in specific instances. In other words, the forums deal with topics not personalities thereby preventing in personal attacks.

“Personally identifying information” refers to individual members' names, and in some online communities may also refer to the naming of specific institutions as well. “Personally identifying information” may sometimes refer to even tertiary identifying information, such as a street someone lives on (or where an institution is located), a place that an individual frequently visits, a name of a pet, a favorite color, or any such information that might help to identify an otherwise anonymous individual and/or institution. “Personally identifying information” usually does not refer to government figures and institutions and celebrity figures and institutions.

Exceptions where the sharing of “personally identifying information” may be allowed would include when such revelations would allow In-Reach to better help an individual online community member, and/or better help the real-world community the online community relates to, and/or better enable In-Reach to accomplish a specific goal as directed by an In-Reach officer. In all such cases, efforts to limit the exposure of an otherwise anonymous member and/or institution would be as much as possible other than to accomplish the goal at hand.

Forums are moderated according to the aforementioned criteria before any online community members' posts appear on the publicly displayed forums. In one embodiment, a human moderator reviews each post. In another embodiment, an automatic review is performed using a program, artificial intelligence, or the like.

The In-Reach online community model provides teens and others a forum for the discussion of private issues such as teen high-risk activity, religious issues, academic issues, social issues, family issues, sexual issues, and any other private teen matters, or other matters for adults such as workplace situations, financial issues, and the like. In a preferred embodiment, the application of the disclosed model exclusively for teens as a peer-to-peer support and discussion forums creates a trustworthy environment where teens are willing to discuss high-risk activities and other private matters more openly than they otherwise generally do. At the same time, because the forums are community-specific, information and data are aggregated organically through the teen discussions. These discussions are therefore more valuable to the given community, as social data, and as commercial data.

The online community provides a peer-to-peer support group, an intervention system, a way to match teens with advisors and/or counselors, advertising, data mining, and a value-based community.

In the preferred embodiment, discussions take place in an online environment. The discussions are real time chats, bulletin board posts, forums, and the like. Whichever embodiment is used, the discussions are preferably clinically supervised, or religiously supervised, or both religiously and clinically supervised. A benefit provided by the moderated forums is a safe peer-to-peer support environment for teens. A natural outflow from the forum environment is a passive or active intervention system. The intervention can come in the form of a helpline. High-risk members of the community, as identified by moderators or an automated system, can be contacted for intervention. Because the system gets teens to open up regarding high-risk activities and/or other emotional, physical, religious, or personal issues, the opportunity for qualified adults and/or professionals (clinicians, clergy, doctors, etc.) to affect an ‘intervention’, or, engage a teen in need of adult/professional support exists. In one embodiment, intervention or counseling is instigated by a teen or user by clicking a link, joining a designated forum to contact an approved adult advisor, or by using provided email(s), or via provided phone number(s). Alternatively, the intervention is instigated by the adult advisor via the teen's or user's email. In the preferred embodiment, upon the teen's registration to join the online community a valid email would be required and validated by the system.

In order to provide counseling, a means exists to match teens with trusted adult advisors (clinicians, doctors, clergy, etc.) from within their own community, while still preserving the anonymity of the teen at the outset. This system would help engage kids involved in or exposed to high-risk behavior that otherwise may be afraid or unwilling to reach out for help. At the same time individual communities, including parents, would have peace-of-mind regarding who is supporting their teens on the Internet.

In one embodiment, to offset the cost of the forum, advertising is sold on the Web site. Advertisement can be provided via discreet one-to-one forums or via group forums.

A tool is provided for presenting online advisement to teens at a communal level, based upon community values. The same tool is also adapted to provide educational material in a similar manner.

The community provides a safe place for users to anonymously discuss issues and current activities and events. The online communities for teens are guided according to the values of their real-world community, be these values religious, social, cultural, etc. Thus, the community and in particular the forums provide a valuable source of data. Included is a tool for aggregating valuable (and otherwise hard-to-acquire) data regarding teen attitudes and behaviors, especially towards high-risk and/or private issues and activities.

In one embodiment, to create the proper environment, the community is only for teens, with the exception of approved adult advisors. The participation of adult advisors is limited and carefully applied so as not to violate the teen's sense of ‘ownership’ of the overall online community. One such approach is to generally limit the adult presence to specific and separate forums within the online community. In one embodiment, Advisors insure application of real-world community's values. In some cases, the real-world community's values may be applied to the online teen community.

The topics for discussion in the community are preferably moderated according to unique criteria. Discussions are predominantly limited to issues seeking peer support. Other non-support issues are allowed on a limited basis for the purposes of maintaining a certain degree of tension-reduction due to the ‘heaviness’ of most issues being discussed. Non-support issues are also allowed for the purpose of creating a deeper level of community/intimacy between members.

Additional guidelines are used to keep the environment safe. These guidelines may include any or all of the following:
no trolling or posting of inflammatory messages intended to cause a disruption in discourse;
no attacking or flaming other members;
no ‘how-to’ posts (posts that teach how to do something like make a bomb, perform a sexual act, roll a joint, etc.) other than from a site-appointed advisor. This does not include peer-to-peer advice on how to solve a support-issue in a constructive manner or similar such advice;
no expletives or vulgarity;
no sexual posts for shock value (i.e. beyond what is needed to explore a support issue such as exploring feeling regarding a particular topic or activity);
no encouragement of other members to engage in dangerous, immoral, or high-risk activities;
no racism, bigotry, or otherwise discriminatory attacks on any race, religion, gender, or people.

The more specifically the online community is tied to a real world community, which creates intimacy increased peer-to-peer validation, the more it must be regionally generalized to provide teens with a comfortable sense of anonymity to prevent real-world community members from being able to guess online community member identities.

To meet the needs of the online community, there is a registration procedure. Users should each select a non-identifying screen-name. The screen-name may not include any known proper names to avoid user identification, and should not be an otherwise used screen-name of registering member. Users also should provide a valid email address. In one embodiment, registration requires validating the email address. Preferably, email addresses such as hotmail, yahoo, dodgeit, and the like are blocked. The user entered data upon registration related to the online and real-world community provides data for the purpose of aggregating such data in a meaningful manner.

The In-Reach online community model has applications to adults for the discussion of private issues such as parenting questions, marriage questions, communal matters, religious matters, and any other private adult matters. Applying the above model for adults exclusively as a peer-to-peer support and discussion forums creates a trustworthy environment wherein adults discuss private matters more openly than they otherwise generally do. At the same time, because the forums are community-specific, the information and data aggregated organically through the adult discussions is more valuable to the given community, as a source of social data, and as a source of commercial data. The an online community will be used for any or all of the following purposes: a peer-to-peer support environment for adults, a passive/active helpline/high-risk intervention system, i.e., a system that, by successfully getting adults to open up regarding high-risk activities and/or other emotional, physical, religious, or personal issues, creates the opportunity for qualified adults and/or professionals (clinicians, clergy, doctors, etc.) to effect an ‘intervention’, or, engage an adult in need of adult/professional support. As discussed above, the intervention or engagement could be instigated by the adult by clicking a link or joining a designated forum to contact an approved adult advisor, or via provided email(s), or via provided phone number(s). The engagement could be instigated by the advisor via the member-adult's email, which would be required and validated upon the member-adult's registration to join the online community, or by the advisor posting to the member-adult via an online forum.

In one embodiment, the system includes means for matching adults with trusted advisors (clinicians, doctors, clergy, etc) from within their own community, while still preserving the anonymity of the member-adult at the outset. This system would help engage adults that otherwise may be afraid to reach out for help. At the same time, individual communities would have peace-of-mind regarding who is supporting their community on the Internet.

Preferably, there is a tool for providing online advisement and education to adults at a communal level, and based upon communal values. Advisement can be provided via discreet one-to-one forums or via group forums. As discussed above, the system provides a means of aggregating valuable and hard-to-acquire data regarding adult attitudes and behaviors, especially towards high-risk and/or private issues and activities.

In order to create these adult forums the several methodologies are employed. The environment is only for adults to speak on a peer-to-peer basis, with the exception of approved adult advisors. Participation of adult advisors is limited and carefully applied so as not to violate the online community's peer-to-peer atmosphere. One such approach is to limit the advisory presence to specific and separate forums within the online community.

Discussions are predominantly limited to issues seeking peer support. As above, other discussion topics are allowed on a limited basis for the purposes of maintaining a certain degree of tension-reduction due to the seriousness of most issues being discussed. Non-support issues are also allowed for the purpose of creating a deeper level of community/intimacy between members. Similar guidelines as discussed above are also applied to the adult forum communities. Additionally, registration requirements will be similar to those discussed above.

The In-Reach online community model is applicable to singles for the discussion of private issues such as dating, marriage, religions, sex, loyalty, and any other private matters, and for the purpose of creating intimate knowledge of each other towards the goal of matchmaking. Applying the above model for singles exclusively as peer-to-peer support and discussion forums creates a trustworthy environment wherein singles are willing to discuss private matters more openly than they otherwise generally do. This would enable singles to better acquaint themselves with each other regarding intimate and sensitive matters as a prelude to being ‘matched’ with each other. At the same time, because the forums are community-specific, the information and data aggregated organically through the single discussions is more valuable to the given community, for collection of social data, and the collection of commercial data.

Such an online community will be used to provide a peer-to-peer support environment for singles, a passive/active relationship counseling system that, by successfully getting singles to open up regarding relationship issues, creates the opportunity for qualified adults and/or professionals (clinicians, clergy, doctors, etc.) to advise a single in need of adult/professional support. This interaction could be instigated by the single by clicking a link or joining a designated forum to contact an approved advisor, or via provided email(s), or via provided phone number(s). Alternatively, the interaction is instigated by the advisor via the single's email, which would be required and validated upon the member-adult's registration to join the online community, or by the advisor posting to the single via an online forum.

Additionally, the system provides a means of matching singles with marriage-candidates in the online community based upon revelations of more private values in online-community's discussions, while still preserving the anonymity of the single at the outset. Further, the system provides a tool for providing online advisement and education to singles at a communal level, and based upon communal values. As above, advisement can be provided via discreet one-to-one forums or via group forums. The system provides a means of aggregating valuable and otherwise hard-to-acquire data regarding single attitudes and behaviors, especially towards relationships and/or religious-sexual behavior out of wedlock. In a preferred embodiment, online communities for singles are guided according to the values of their real-world community, whether they are religious, social, cultural, etc.

A matchmaking system is included whereby members may request and accept introductions to each other for the purpose of dating and marriage. In order to create these single forums the several methodologies are employed. The environment is only for singles to speak on a peer-to-peer basis, with the exception of approved advisors. Participation of advisors is limited and carefully applied so as not to violate the online community's peer-to-peer atmosphere. One approach is to limit the advisory presence to specific and separate forums within the online community. In a preferred embodiment, real-world community's values are applied to the online singles community. Further, discussions are predominantly limited to social issues and issues seeking peer support. Non-social and non-support issues are allowed on a limited basis for the purposes of maintaining a certain degree of tension-reduction, due to the gravity of a dating site. Non-social and non-support issues are also allowed for the purpose of creating a deeper level of community/intimacy between members. Additional guidelines as those discussed above keep the environments safe. The guidelines may include any or all of the following no trolling, no attacking or flaming other members, no ‘how-to’ posts (posts that teach how to do something like make a bomb, perform a sexual act, take drugs, etc.) other than from a site-appointed advisor, on in otherwise approved and designated forums (e.g. peer-to-peer sexual advice). This does not include peer-to-peer advice on how to solve a social issue or support-issue in a constructive manner or similar such advice. No expletives or vulgarity, no sexual posts for shock value beyond what is needed to explore a support issue, no encouragement of other members to engage in dangerous, immoral, or high-risk activities, no racism, bigotry or otherwise discriminatory attacks on any race, religion, gender, or people.

The more specifically the singles online community is tied to a real world community thereby creating intimacy and increased peer-to-peer validation the more it must be regionally generalized to provide singles with a comfortable sense of anonymity and prevent real-world community members from being able to guess online community member identities. Special registration requirements include, but are not limited to a non-identifying screen-name, the screen-name may not include any known proper names, and should not be an otherwise used screen-name of registering member, a valid email address that would require validating the email and general profiling information related to the adult and/or real-world community for the purpose of aggregating data in a meaningful manner.

The In-Reach online community model is applicable to institutions, such as government, community, commercial, charities, non-profits, and the like, for the discussion of sensitive institution-related issues. The issues include but are not limited to management behavior, leadership conduct, operational and day-to-day concerns, service, hierarchy, mission, and any other institutionally related matters that are applicable to the institution. The general services and components are similar to those discussed above.

The In-Reach online community model is also applicable to leadership groups such as government, clergy, education, community, corporate, non-profit, and the like, for the discussion of sensitive leadership-related issues. The nature of the leadership roles is investigated and applicable discussions exist. The general services and components are similar to those discussed above.

The In-Reach online community is also applicable to professional groups such as doctors, lawyers, accountants, and the like, for the discussion of sensitive profession-related issues such as ethics, treatments, procedures, rules, and other topics. It should be noted that each professional group has its own set of discussion forums. In another embodiment, several professions are grouped together. The general services and components are similar to those discussed above.

In one embodiment, a research application is integrated into an online community for the purposes of conducting queries, studying, and otherwise examining aggregated information/data related to and submitted by the online-community's members. According to a fist embodiment, the research application is used commercially, similar to a Forrester Research type database. The research application would be available from the same website as the forums, or alternatively, would be linked to the forums. In another embodiment the research application would be available from a separate website and/or standalone application, and would allow subscribers to research, cross-reference, and otherwise examine aggregated data.

The research application would allow the publishing of reports and regularly published reports. In one embodiment, the research application is subscription-based (weekly, monthly, quarterly, annually, etc), or on a fee-per-use/report basis (or any other type of commercial variation) for data mining. Preferably, data entry, surveys, queries, and the like are free to participants providing data. In a second embodiment, access to the data would be free of charge. In a third embodiment, data mining is limited to the online communities and forums without additional surveys or the like.

The present invention may be described herein in terms of functional block components, code listings, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements.

Further, it should be noted that the present invention may employ any number of conventional techniques for data transmission, signaling, data processing, network control, and the like.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

In the specification, the term “media” means any medium that can record data therein. The term “media” includes, for instance, a disk shaped media for such as CD-ROM (compact disc-read only memory), magneto optical disc or MO, digital video disc-read only memory or DVD-ROM, digital video disc-random access memory or DVD-RAM, a floppy disc, a memory chip such as random access memory or RAM, read only memory or ROM, erasable programmable read only memory or E-PROM, electrical erasable programmable read only memory or EE-PROM, a rewriteable card-type read only memory such as a smart card, a magnetic tape, a hard disc, and any other suitable means for storing a program therein.

A recording media storing a program for accomplishing the above mentioned apparatus maybe accomplished by programming functions of the above mentioned apparatuses with a programming language readable by a computer or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device, any suitable device for performing computations in accordance with a computer program may be used. Examples of such devices include a personal computer, a laptop computer, a microprocessor, a programmable logic device, or an application specific integrated circuit.

Applicant notes that the present invention solves a plurality of technical problems. In particular, the present invention enhances the collection of characteristic data. Additionally, the present invention provides means for aggregating personal data relating to a specific population, i.e., a specific virtual community. Further, the system provides means for aggregating the data to identify specific community characteristics.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

What is claimed is:

1. A method of hosting a moderated anonymous forum comprising:
receiving and storing login data particular to a user;
receiving and storing personal data associated with the user;
receiving a post message from the user;
removing personal data and/or login data from the post message;
posting the message to a community specific forum;
flagging the message for review based on predetermined criteria;
extracting the personal data from a targeted population; and
aggregating the personal data relating to a specific population.

2. The method of hosting a moderated anonymous forum according to claim 1, further comprising:
effecting an intervention for a user at risk for problems.

3. The method of hosting a moderated anonymous forum according to claim 2, wherein the problems are selected from the group consisting of suicide, drug abuse, alcohol abuse, eating disorders, physical abuse, sexual abuse, self mutilation, religious questions (crises of faith), or violent behavior.

4. The method of hosting a moderated anonymous forum according to claim 1, further comprising:
matching individuals seeking advice with advisors selected from the group consisting of clergy, clinicians, health counselors, professional advisors, and social workers using predetermined criteria.

5. The method of hosting a moderated anonymous forum according to claim 1, wherein said message transmission is an electronic mail message.

6. The method of hosting a moderated anonymous forum according to claim 1, wherein said message is a wireless text messaging message.

7. The method of hosting a moderated anonymous forum according to claim 1, wherein said message is a physical hardcopy paper message.

8. The method of hosting a moderated anonymous forum according to claim 1, wherein said message is a facsimile.

9. The method of hosting a moderated anonymous forum according to claim 1, wherein said message is a voice message captured through a voice response system.

10. The method of hosting a moderated anonymous forum according to claim 1, wherein said message is an instant messaging message.

11. The method of hosting a moderated anonymous forum according to claim 1, wherein said message is generated using a form.

12. The method of hosting a moderated anonymous forum according to claim 1, wherein the message is reviewed prior to posting.

13. The method of hosting a moderated anonymous forum according to claim 1, wherein the message is reviewed after posting.

14. The method of hosting a moderated anonymous forum according to claim 1, wherein the message has no associated data to identify the user.

15. The method of hosting a moderated anonymous forum according to claim 1, wherein the message is masked with a random name.

16. The method of hosting a moderated anonymous forum according to claim 15, wherein random name is generated by the system.

17. The method of hosting a moderated anonymous forum according to claim 1, further comprising:
creating a sub-group, wherein the subgroup is established by a user, the user determining criteria for subgroup participants.

18. The method of hosting a moderated anonymous forum according to claim 17 wherein the sub-group is invisible to users not meeting the criteria for participants.

19. The method of hosting a moderated anonymous forum according to claim 1, further comprising:
establishing a forum linking a plurality of virtual communities.

20. A method of hosting a forum comprising:
receiving and storing login data particular to a user;
receiving and storing personal data associated with the user;
receiving a post message from the user;
posting the message to a community specific forum;
flagging the message for review based on predetermined criteria;
extracting the personal data from a targeted population; and
aggregating the personal data relating to a specific population.

21. The method of hosting a forum according to claim 20, further comprising:
effecting an intervention for a user at risk for problems.

22. The method of hosting a forum according to claim 21, wherein the problems are selected from the group consisting of suicide, drug abuse, alcohol abuse, eating disorders, physical abuse, sexual abuse, self mutilation, religious questions (crises of faith), or violent behavior.

23. The method of hosting a forum according to claim 20, further comprising:
connecting individuals seeking advice with advisors selected from the group consisting of clergy, clinicians, health counselors, professional advisors, and social workers.

24. The method of hosting a forum according to claim 20, further comprising:
receiving an instruction to strip user data from the message prior to or after posting the message.

25. The method of hosting a forum according to claim 20, wherein the message is reviewed prior to posting.

26. The method of hosting a forum according to claim 20, wherein the message is reviewed after posting.

27. The method of hosting a forum according to claim 20, wherein the personal data is stored in a subscription-based searchable database.

28. The method of hosting a forum according to claim 20, wherein the message is masked with a random name.

29. The method of hosting a forum according to claim 28, wherein the random name is generated by the system.

30. The method of hosting a forum according to claim 20, further comprising:
creating a sub-group, wherein the subgroup is established by a user, the user determining criteria for subgroup participants.

31. The method of hosting a forum according to claim 30 wherein the sub-group is invisible to users not meeting the criteria for participants.

32. The method of hosting a forum according to claim 20, further comprising:
establishing a forum linking a plurality of virtual communities.

33. A system for hosting a moderated anonymous forum comprising:
a first memory location for storing login data;
a second memory location for storing personal data;
a receiver for receiving messages;
an extractor for extracting personal information and data from a targeted population;
a means of aggregating personal data relating to a specific population; and
a means of effecting interventions for individuals at risk.

34. The system for hosting a moderated anonymous forum according to claim 33, further comprising:
a subscription-based searchable database of anonymous personal data relating to targeted populations.

35. The system for hosting a moderated anonymous forum according to claim 34, further comprising:
a data miner to mined adapted to extract characteristic data relating to the users and forum topics.

36. The method of hosting a moderated anonymous forum according to claim 33, wherein the message is masked with a random name.

37. The method of hosting a moderated anonymous forum according to claim 36, wherein random name is generated by the system.
